(19) United States
(12) Patent Application Publication
(10) Pub. No.: US 2019/0015921 A1
(43) Pub. Date: Jan. 17, 2019

(54) LASER WIRE FEEDING SYSTEM

(71) Applicants: SOUTHERN TAIWAN UNIVERSITY OF SCIENCE AND TECHNOLOGY, Tainan City (TW); KUANG TAI METAL INDUSTRIAL CO., LTD., Tainan City (TW)

(72) Inventors: CHENG HSIN CHUANG, TAINAN CITY (TW); I CHIN CHOU, TAINAN CITY (TW); YU CHUN CHANG, TAINAN CITY (TW); HUA CHENG CHIANG, TAINAN CITY (TW); CHING CHIA CHEN, TAINAN CITY (TW)

(21) Appl. No.: 15/651,095

(22) Filed: Jul. 17, 2017

(51) Int. Cl. B23K 9/12; B23K 26/70; B23K 26/035; B23K 26/042; B23K 26/04; B23K 26/08

(52) U.S. Cl. CPC B23K 9/124; B23K 26/702; B23K 26/0892; B23K 26/042; B23K 26/048; B23K 26/035

(57) ABSTRACT

A laser wire feeding system includes a wire feeding device, a laser device, a first controller, and a second controller, and the first and second controllers are provided for sensing whether or not the wire feeding device normally conveys wires and whether or not a wire output end of the wire feeding device shifts is offset from the laser irradiation position of the laser device, and driving a motor to shift a horizontal shifting seat fixed with the wire feeding device to fine tune the wire feeding position according to the offset position.

### FIELD OF INVENTION

The present invention relates to a laser wire feeding system, in particular to the laser wire feeding system capable of detecting whether or not the position of a wire input end of a wire feeding device is offset and timely adjusting and correcting the deviated direction to allow a laser welding device to perform its operation accurately and quickly.

### BACKGROUND OF INVENTION

### 1. Description of the Related Art

Wire feeding device is a common device used for conveying a fine metal wire to a repair welding machine, a welding machine, or any machine that is used for repairing precision articles. In recent years, 3D printers are introduced and developed quickly, and the 3D printing technology not just becomes more and more popular only, but 3D printing related materials or wire materials are studied and developed extensively by manufacturers of the related industry.

Since the wire feeding device generally works together with a laser welding machine to perform the work of melting, welding, and repairing metal items, therefore the accuracy of conveying the wire material stably and the consistent wire output position of the wire metal are major factors for determining the quality of the welding and repair work. Therefore, if the wire feeding device cannot match with the operating position of the welding machine, or the deviated wire output position cannot be corrected timely during the wire feeding process, it will take consume much operating time and result in poor quality.

With reference to R.O.C. Pat. No. M523533 entitled “Laser wire feeding machine” for a related conventional wire feeding device of a laser welding machine, the laser wire feeding machine of the aforementioned patent comprises a power wheel, first and second link rods installed in a main body of the laser wire feeding machine and driven by a power source, a roller installed under the power wheel for adjusting the tightness of the conveyed wire, a fine-tuning mechanism installed between the first and second link rods, and a guiding pin formed at an end of the second link rod and installed onto an angle adjusting mechanism, so that the fine-tuning mechanism and the angle adjusting mechanism can convey a welding rod accurately to provide a stable and consistent path of the welding rod to the guiding pin through the roller in order to perform a contact welding operation.

### 2. Summary of the Invention

In view of the aforementioned drawbacks of the conventional laser welding machine generally having a deviated wire feeding position of the wire feeding device and affecting the welding time and quality, it is a primary objective of the present invention to provide a laser welding machine with a controller for adjusting the wire output position, so that the wire feeding device can match with the laser welding position and/or fine-tune or correct the wire feeding position timely.

Another objective of the present invention is to provide a laser feeding system that connects controllers for controlling an output wire to a metal substrate and a metal wire through conductive wires respectively in order to control the wire outputted from the wire feeding machine by using a circuit signal detection method.

To achieve the aforementioned and other objectives, the present invention provides a laser wire feeding system, comprising: a wire feeding device, for conveying and outputting a metal wire from a wire input end to a wire output end by a power source; a laser device, for melting and welding the metal wire outputted from the wire output end, and having a camera lens and a screen installed thereto, and the camera lens being provided for shooting an image of the wire output end and displaying the image of the wire output end on the screen, and using the beam irradiation position of the laser device as a reference point of the screen; a metal substrate, serving as a working surface for the laser device to weld the metal wire; a fixed seat, fixed to the laser device; a horizontal shifting seat, including a first motor installed thereto, and a second motor installed between the fixed seat and the horizontal shifting seat, so that the horizontal shifting seat can be shifted by using a driving shaft of the second motor as the axis; a vertical shifting seat, secured to the wire feeding device, and a driving shaft of the first motor being passed and fixed to the vertical shifting seat, so that the vertical shifting seat can be shifted by using the driving shaft of the first motor as the axis; a first controller, having two conductive wires coupled thereto, and ends of the two conductive wires being contacted with the metal wire and the metal substrate respectively to form a circuit, and capable of sensing a signal of the circuit after being conducted, and controlling the wire feeding device according to the signal to convey the metal wire; and a second controller, including an image computing unit, and electrically coupled to the screen, for receiving a screen image of the screen, and computing and determining whether or not the output position of the metal wire from the wire feeding device is offset from the reference point, and driving the second motor to shift the horizontal shifting seat for a fine-tune if the output position of the metal wire is offset.

In the aforementioned laser wire feeding system, the first controller outputs a voltage to the circuit formed by two conductive wires, and a circuit signal may be used to determine whether or not the metal wire is contacted with the metal substrate, so as to control a power source to drive the wire feeding device to feed the metal wire if the metal wire is not contacted, and using a camera lens to shoot an image at the position of the wire output end during the process of feeding the metal wire and display the image on the screen, and the image computing unit computes the offset position of the wire output end with respect to the reference point in order to drive the second motor to shift the horizontal shifting seat according to the offset position to fine tune the wire feeding position.

### BRIEF DESCRIPTION OF THE DRAWINGS

FIG. 1 is an exploded view of the present invention;

FIG. 2 is a perspective view of the present invention;

FIG. 3 is a front view of the present invention; and

FIGS. 4-6 are schematic views showing the position adjustment of the present invention.

### DESCRIPTION OF THE PREFERRED EMBODIMENTS

The above and other objects, features and advantages of this disclosure will become apparent from the following detailed description taken with the accompanying drawings.

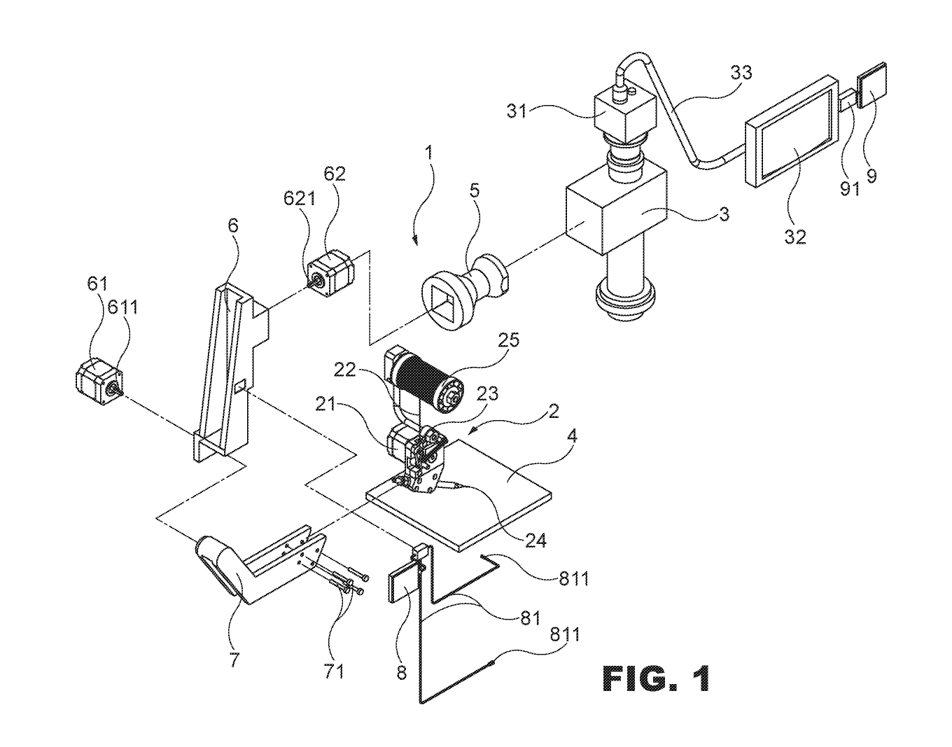

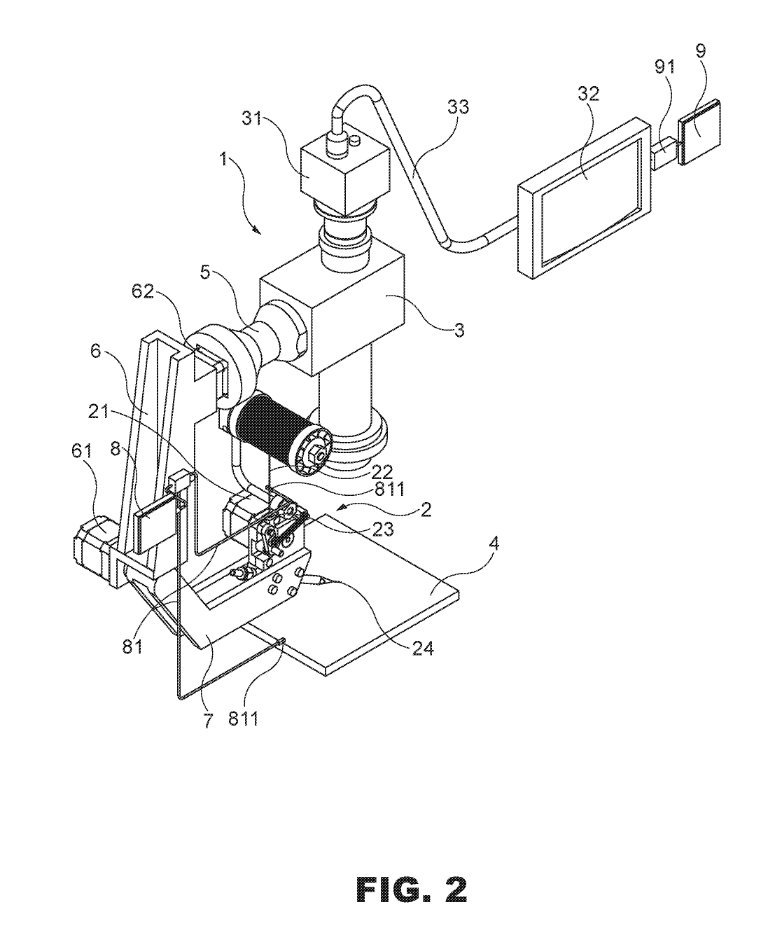

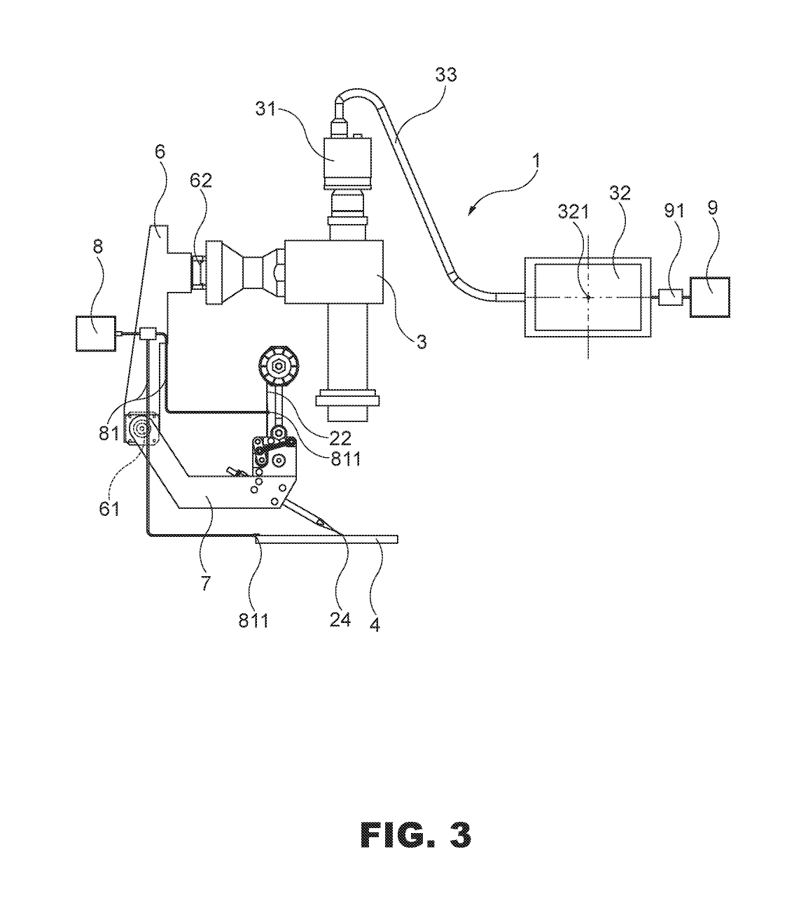

With reference to FIGS. 1 and 2 for a laser wire feeding system of the present invention, the laser wire feeding system 1 comprises a wire feeding device 2, a laser device 3, a metal substrate 4, a fixed seat 5, a horizontal shifting seat 6, a vertical shifting seat 7, a first controller 8 and a second controller 9. The wire feeding device 2 conveys a metal wire 22 wound around a wire bobbin 25 from a wire input end 23 to a wire output end 24 by a power source 21. In a preferred embodiment of the present invention, the power source 21 is a motor, and the metal wire 22 has a wire diameter of 0.1˜0.5 MM. The laser device 3 is provided for melting and welding the metal wire 22 outputted from the wire output end 24 of the wire feeding device 2, and a camera lens 31 is installed and coupled to a screen 32 through a signal line 33, wherein the camera lens 31 is provided for shooting an image of the wire output end 24 and displaying the image on the screen 32, and the beam irradiation position of the laser device 3 is used as a reference point 321 of the screen 32 (see FIG. 3 as well). The metal substrate 4 is disposed under the wire feeding device 2 and provided as a working surface for the laser device 3 to weld the metal wire 22. The fixed seat 5 is fixed to the laser device 3. The horizontal shifting seat 6 includes a first motor 61, and a second motor 62 installed between the fixed seat 5 and the horizontal shifting seat 6, so that the horizontal shifting seat 6 can be shifted by using a driving shaft 621 of the second motor 62 as the axis. The vertical shifting seat 7 is secured to the wire feeding device 2 through the fixing element 71, and a driving shaft 611 of the first motor 61 is passed and fixed to the vertical shifting seat 7, so that the vertical shifting seat 7 can be shifted by using the driving shaft 611 of the first motor 61 as the axis. The first controller 8 is fixed to the horizontal shifting seat 6 and coupled to two soft conductive wires 81, so that ends 811 of the two conductive wires 81 are contacted with the metal wire 22 and the metal substrate 4 respectively to form a circuit and a signal of the circuit can be sensed after the electric conduction, and the wire feeding device 2 is controlled to convey the metal wire 22 according to the signal. The second controller 9 includes an image computing unit 91 electrically coupled to the screen 32, and the second controller 9 is provided for receiving a screen image of the screen 32, and the image computing unit 91 is provided for computing and determining whether or not the output position of the metal wire outputted from the wire feeding device 2 is offset from the reference point 321. If the screen image is out of focus, or the output position is offset from the reference point 321, the second motor 62 or the first motor 61 will drive the horizontal shifting seat 6 or vertical shifting seat 7 to shift for a fine-tune.

In FIGS. 2 and 3, the power source 21 drives the wire feeding device 2 to convey metal wires during the operation of the laser wire feeding system 1 of the present invention. In the meantime, the first controller 8 outputs a weak voltage at the conductive wire 81. After an electric current is passed through the circuit formed by the metal substrate 4 and the metal wire 22, the first controller 8 uses the received circuit signal to determine whether or not the wire feeding device 2 works normally. If the first controller 8 receives the signal of the conducted circuit, it shows that the metal wire 22 outputted from the wire output end 24 of the wire feeding device 2 is contacted with the metal substrate 4 or the metal wire 22 disposed on the metal substrate 4. On the other hand, if the first controller 8 cannot receive the signal of the conducted circuit, it shows that the metal wire 22 outputted from the wire output end 24 of the wire feeding device 2 is not contacted with the metal substrate 4 or the metal wire 22 disposed on the metal substrate 4. Now, the first controller 8 will control the power source 21 to drive the wire feeding device 2 to convey and feed the metal wire, and a laser device 3 with a laser head irradiates a laser beam to melt the metal wire 22 in order to perform the operation of welding, repairing a metal piece, and stacking and manufacturing objects repeatedly.

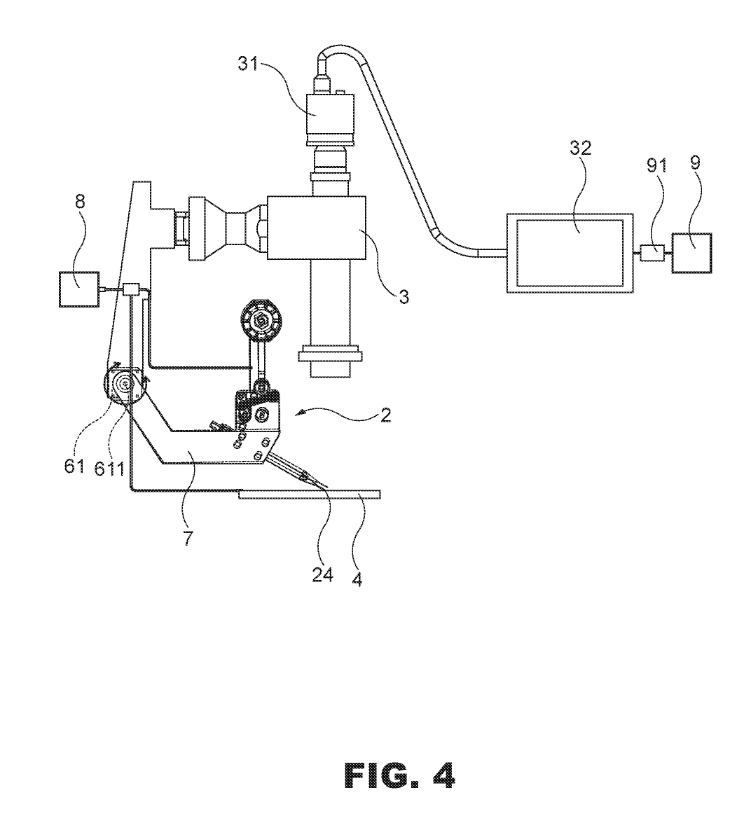

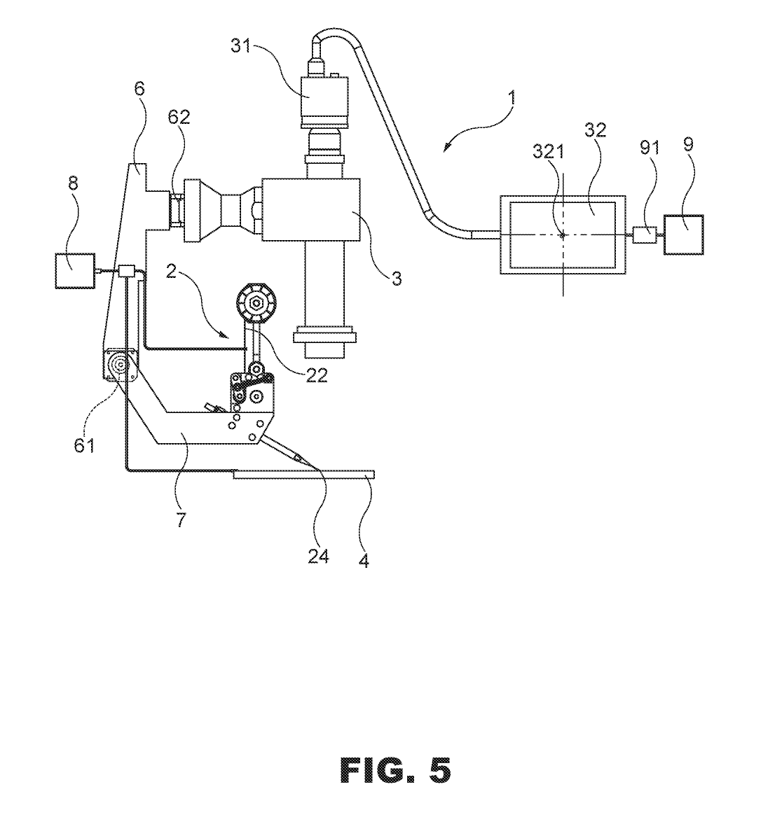

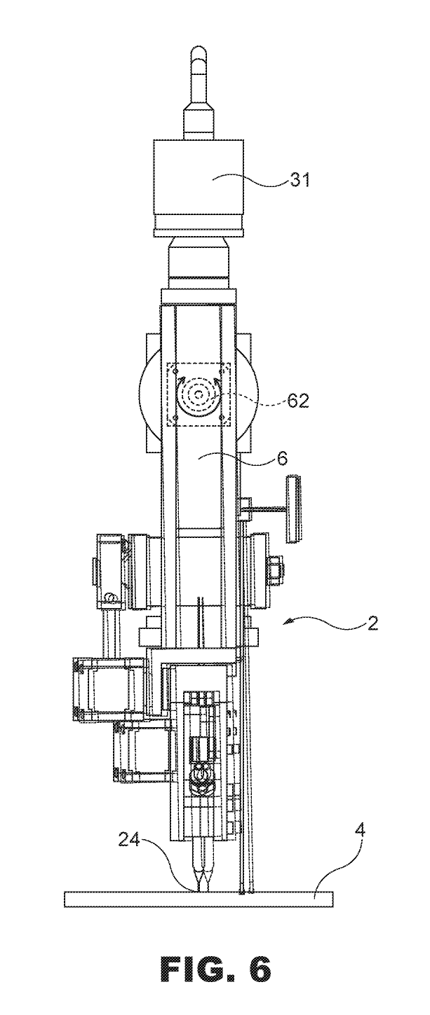

In FIG. 4, when the wire feeding device 2 and the laser device 3 continues conveying wires and performing the melting/welding operation, the camera lens 31 will shoot an image at the position of the wire output end 24. If the positional image is out of focus, the second controller 9 will control the driving shaft 611 of the first motor 61 to shift the vertical shifting seat 7 in the vertical direction to fine tune the up and down position of the wire output end 24 until the image of the wire output end 24 captured by the camera lens 31 is focused. An image computing unit 91 is provided for computing and determining whether or not the position of the captured image of the wire output end 24 is offset from the beam irradiation position of the laser device 3 (which is the reference point 321 of the screen 32 as shown in FIG. 5). If the position of the wire output end 24 is offset, the second controller 9 will drive the second motor 62 to shift the horizontal shifting seat 6 in the horizontal direction (as shown in FIG. 6), so that the wire output end 24 of the wire feeding device 2 can be fine tuned to the position corresponding to the reference point 321 to achieve the effect of correcting the position of the wire input end 24 automatically.

In view of the description above, the laser wire feeding system of the present invention has the following effects:

In the laser wire feeding system of the present invention, the first and second controllers automatically sense whether or not the wire feeding device works normally to convey the metal wires and whether or not the position of the wire output end is offset from the reference point in order to make the correction timely, so that the laser wire feeding system can position the metal wire accurately and continue supplying the metal wire stably. Further, the laser wire feeding system of the invention can be applied for fine welding, repairing metal pieces, metallic 3D printing, or any area that requires fine operations, and the invention can reduce labor and manufacturing time.

In the laser wire feeding system of the present invention, the first controller is coupled to the metal substrate and the metal wire by the conductive wires to form a simple circuit, and the simple structure can ensure that the metal wire is contacted with the substrate to facilitate covering the metal wire repeatedly by laser welding, and the stacking effect can be used to manufacture products and achieve the effect of metal 3D printing.

While the invention has been described by means of specific embodiments, numerous modifications and variations could be made thereto by those skilled in the art without departing from the scope and spirit of the invention set forth in the claims.

What is claimed is:

1. A laser wire feeding system, comprising:
a wire feeding device, for conveying and outputting a metal wire from a wire input end to a wire output end by a power source;
a laser device, for melting and welding the metal wire outputted from the wire output end, and having a camera lens and a screen installed thereto, and the camera lens being provided for shooting an image of the wire output end and displaying the image of the wire output end on the screen, and using the beam irradiation position of the laser device as a reference point of the screen;
a metal substrate, serving as a working surface for the laser device to weld the metal wire;
a fixed seat, fixed to the laser device;
a horizontal shifting seat, including a first motor installed thereto, and a second motor installed between the fixed seat and the horizontal shifting seat, so that the horizontal shifting seat can be shifted by using a driving shaft of the second motor as the axis;
a vertical shifting seat, secured to the wire feeding device, and a driving shaft of the first motor being passed and fixed to the vertical shifting seat, so that the vertical shifting seat can be shifted by using the driving shaft of the first motor as the axis;
a first controller, having two conductive wires coupled thereto, and ends of the two conductive wires being contacted with the metal wire and the metal substrate respectively to form a circuit, and capable of sensing a signal of the circuit after being conducted, and controlling the wire feeding device according to the signal to convey the metal wire; and
a second controller, including an image computing unit, and electrically coupled to the screen, for receiving a screen image of the screen, and computing and determining whether or not the output position of the metal wire from the wire feeding device is offset from the reference point, and driving the second motor to shift the horizontal shifting seat for a fine-tune if the output position of the metal wire is offset.

2. The laser wire feeding system of claim 1, wherein the first motor is driven to fine tune the up and down shifting of the vertical shifting seat, so that the screen image is focused, when the screen image received by the second controller is out of focus.

3. The laser wire feeding system of claim 1, wherein the power source is a motor.

4. The laser wire feeding system of claim 1, wherein the wire feeding device further comprises a wire bobbin for winding the metal wire to be conveyed.

5. The laser wire feeding system of claim 1, wherein the metal wire has a wire diameter of 0.1˜0.5 MM.

6. The laser wire feeding system of claim 1, wherein the camera lens and the screen are coupled with each other through a signal line.

7. The laser wire feeding system of claim 1, wherein the vertical shifting seat is passed and secured to the wire feeding device through the fixing element.

8. The laser wire feeding system of claim 1, wherein the first controller is fixed to the horizontal shifting seat.

9. The laser wire feeding system of claim 1, wherein the conductive wire is made of a conductive soft wire material.
